(19) United States
(12) Patent Application Publication
(10) Pub. No.: US 2006/0207453 A1
(43) Pub. Date: Sep. 21, 2006

(54) Apparatus and method for a rubber sleeve for a printing press

(75) Inventors: Alfons Grieser, Sielenbach (DE); Eduard Hoffmann, Bobingen (DE); Georg Schmid, Neusaess (DE); Helmut Stuhlmiller, Altenmuenster (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 11/384,621

(22) Filed: Mar. 20, 2006

(30) Foreign Application Priority Data
Mar. 21, 2005 (DE) 10 2005 013 424.6

(51) Int. Cl. B41F 27/06

(52) U.S. Cl. 101/376

(57) ABSTRACT

A rubber sleeve for a printing press, having an at least two-layer structure, is disclosed. The rubber sleeve has an inner layer formed as a carrier layer and an outer layer formed as a functional layer and used for the printing process, the carrier layer and the functional layer being a constituent part of a rubber blanket, which is shaped in the manner of a sleeve in order to form the rubber sleeve and is connected to itself in the region of mutually opposite joint faces of the carrier layer and the functional layer. At least the joint faces of the carrier layer being enlarged in such a way that the same absorb circumferential forces acting on the rubber sleeve.

This application claims the priority of German Patent Document No. 10 2005 013 424.6, filed Mar. 21, 2005, the disclosure of which is expressly incorporated by reference herein.

### BACKGROUND AND SUMMARY OF THE INVENTION

The invention relates to a rubber sleeve for a printing press. Furthermore, the invention relates to a method for the production of a rubber sleeve for a printing press.

In principle, two methods for the production of a rubber sleeve are known from practice. According to a first method known from practice for the production of a rubber sleeve, a rigid carrier sleeve made of metal or composite material is provided, further layers of the rubber sleeve being applied to this carrier sleeve one after another. This preferably takes place using what is referred to as a coating method. According to a second method known from practice for the production of a rubber sleeve, a rigid carrier sleeve made of metal or composite material and, furthermore, as a semi-finished product, a rubber blanket having an at least two-layer structure is likewise provided, the rubber blanket being wound around the rigid carrier sleeve and firmly connected to the rigid carrier sleeve. Such rubber sleeves accordingly always have a rigid carrier sleeve made of metal or composite material. This results in high manufacturing costs for a rubber sleeve. Since the carrier sleeve of the rubber sleeves known from the prior art is rigid and accordingly is inflexible and inelastic, close tolerances also have to be maintained in accordance with the prior art in order to ensure the ability to mount a rubber sleeve on a rubber-covered cylinder of a printing press.

Taking this as a starting point, the present invention is based on the problem of providing a novel type of rubber sleeve and a novel type of method for the production of the same.

According to a first aspect of the present invention, a rubber sleeve for a printing press having an at least two-layer structure is provided, having an inner layer formed as a carrier layer and an outer layer formed as a functional layer and used for the printing process, the carrier layer and the functional layer being a constituent part of a rubber blanket, which is shaped in the manner of a sleeve in order to form the rubber sleeve and is connected to itself, in the region of mutually opposite joint faces of the carrier layer and functional layer, and at least the joint faces of the carrier layer being enlarged in such a way that the same absorb circumferential forces acting on the rubber sleeve.

According to a second aspect of the present invention, a rubber sleeve for a printing press having an at least two-layer structure is provided, having an inner layer formed as a carrier layer and an outer layer formed as a functional layer and used for the printing process, the carrier layer and the functional layer being a constituent part of a rubber blanket, which is shaped in the manner of a sleeve in order to form the rubber sleeve and is connected to itself in the region of mutually opposite joint faces of the carrier layer and functional layer, and a connecting element being let into the carrier layer in order to absorb circumferential forces acting on the rubber sleeve.

The rubber sleeves according to the invention, be they rubber sleeves according to the first aspect of the present invention or else according to the second aspect of the present invention, no longer have a rigid carrier sleeve. This results in lower manufacturing costs. Furthermore, greater tolerances in the dimensional stability of the rubber sleeves are possible.

All the layers of the rubber sleeves according to the invention are a constituent part of a rubber blanket which is used as a semi-finished product during the production of the rubber sleeves according to the invention. The rubber blanket is shaped in the manner of a sleeve and connected to itself in the region of its joint faces. Forces acting on the rubber sleeve, specifically forces acting in the circumferential direction, can be absorbed by the rubber sleeve because either, in accordance with the first aspect of the invention, the joint faces of the carrier layer are enlarged or, according to the second aspect of the invention, a connecting element is let into the carrier layer.

### BRIEF DESCRIPTION OF THE DRAWINGS

Preferred developments of the invention emerge from the following description. Exemplary embodiments of the invention, without being restricted thereto, will be explained in more detail by using the drawings, in which:

FIG. 1 shows a detail of a rubber sleeve according to the invention for a printing press according to a first exemplary embodiment of the invention, in a perspective side view;

FIG. 2 shows the detail II of the rubber sleeve according to the invention from FIG. 1 in a perspective side view;

FIG. 3 shows a detail of a rubber sleeve according to the invention for a printing press according to a second exemplary embodiment of the invention, in a view analogous to FIG. 2;

FIG. 4 shows a detail of a rubber sleeve according to the invention for a printing press according to a third exemplary embodiment of the invention, in a view analogous to FIG. 2; and

FIG. 5 shows a detail of a rubber sleeve according to the invention for a printing press according to a fourth exemplary embodiment of the invention, in a view analogous to FIG. 2.

### DETAILED DESCRIPTION OF THE DRAWINGS

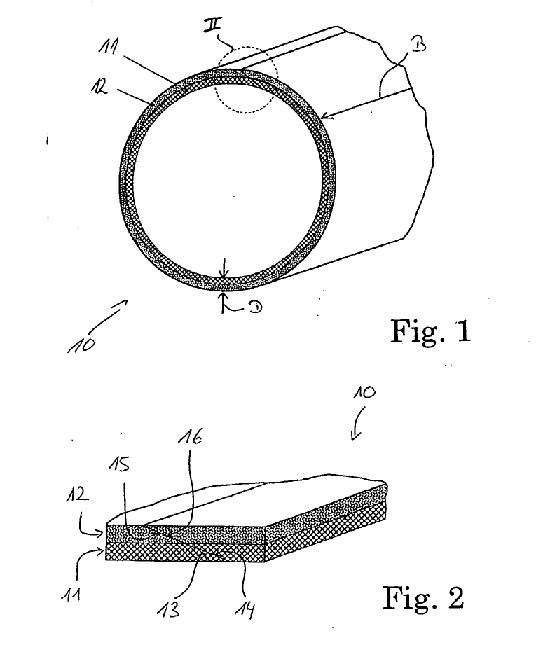

In the following text, the present invention will be described in greater detail with reference to FIGS. 1 to 5.

FIGS. 1 and 2 show a rubber sleeve 10 according to the invention for a printing press, the rubber sleeve 10 shown in FIGS. 1 and 2 having a two-layer structure. Thus, the rubber sleeve 10 has an inner layer formed as a carrier layer 11 and an outer layer formed as a functional layer 12 and used for the printing process. The layers of the rubber sleeve 10, the carrier layer 11 and functional layer 12 in the exemplary embodiment shown, are all a constituent part of a rubber blanket which is used as a semi-finished product for the production of the rubber sleeve 10 according to the invention.

The rubber blanket comprising the carrier layer 11 and the functional layer 12 is shaped in the manner of a sleeve in order to produce the rubber sleeve 10 according to the invention and is connected to itself in the region of mutually opposite joint faces. In this case, the connection is made both in the region of mutually opposite joint faces 13 and 14 of the carrier layer 11 and in the region of mutually opposite joint faces 15 and 16 of the functional layer 12.

The joint faces 13 and 14 of the carrier layer 11 and also the joint faces 15 and 16 of the functional layer 12 are bounded by joint edges, specifically by first joint edges which extend over the axial width B of the rubber sleeve 10 and by second joint edges which extend over the radial thickness D of the rubber sleeve 10.

In the exemplary embodiment of FIGS. 1 and 2, both the joint faces 13 and 14 of the carrier layer 11 and the joint faces 15 and 16 of the functional layer 12 are set obliquely with respect to the radial direction of the rubber sleeve 10. This results in joint faces which are enlarged in comparison with joint faces which run in the radial direction.

As can be gathered from FIG. 2, the joint faces 13 and 14 of the carrier layer 11 and the joint faces 15 and 16 of the functional layer 12 overlap in the circumferential direction. This is achieved by the second joint edges of carrier layer 11 and functional layer 12 in each case being set obliquely in the radial direction of the rubber sleeve 10. In the exemplary embodiment of FIGS. 1 and 2, the first joint edges extend linearly over the axial width B of the rubber sleeve 10.

As a result of the enlargement of the mutually opposite joint faces 13 and 14 of the carrier layer 11, the same can safely absorb forces acting on the rubber sleeve 10 in the circumferential direction and in this way ensure secure seating of the rubber sleeve 10 on a rubber-covered cylinder of a printing press. This makes it possible to dispense with the rigid carrier sleeves made of metal or composite material required in the rubber sleeves known from the prior art. The rubber sleeve according to the invention is formed exclusively by the layers of the rubber blanket which is used as a semi-finished product during the production of the rubber sleeve 10 according to the invention.

The carrier layer 11 of the rubber sleeve 10 according to the invention is formed as a flexible or elastic carrier layer made of a plastic, which is fiber-reinforced with the aid of plastic fibers. The outer functional layer 12 is used for the printing process. Further layers, for example a compressible layer, a register layer and a top layer, can be positioned in the functional layer 12, their joint faces being formed like the joint faces of the carrier layer and/or functional layer.

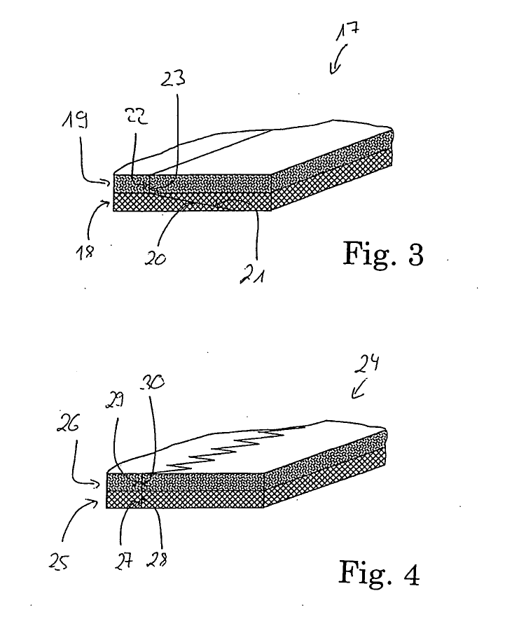

FIG. 3 shows a detail of a rubber sleeve 17 according to a second exemplary embodiment of the invention. In the exemplary embodiment of FIG. 3, the rubber sleeve 17 again has a two-layer structure comprising a carrier layer 18 and the functional layer 19 used for the printing process, carrier layer 18 and functional layer 19 again being a constituent part of a rubber blanket used as a semi-finished product during the production of the rubber sleeve 17.

During the production of the rubber sleeve 17 of the exemplary embodiment of FIG. 3, joint faces 20 and 21 of the carrier layer 18 and joint faces 22 and 23 of the functional layer 19 are again connected to each other in order to form the rubber sleeve 17 following the sleeve-like shaping of the rubber blanket, only the joint faces 20 and 21 of the carrier layer 18 being set obliquely with respect to the radial direction of the rubber sleeve 17 in the exemplary embodiment of FIG. 3, the joint faces 22 and 23 of the functional layer 19, on the other hand, extending in the radial direction of the rubber sleeve. Accordingly, in the exemplary embodiment of FIG. 3, only the second edges of the carrier layer 18 are set obliquely with respect to the radial direction of the rubber sleeve 17, whereas the second joint edges of the functional layer 19 extend in the radial direction of the rubber sleeve 17. It follows from this that, in the exemplary embodiment of FIG. 3, only the joint faces 20 and 21 of the carrier layer are enlarged. As can be gathered from FIG. 3, the joint faces 20 and 21 of the carrier layer 18 overlap in the circumferential direction.

A further exemplary embodiment of a rubber sleeve 24 according to the invention is shown by FIG. 4, the rubber sleeve in the exemplary embodiment of FIG. 4 also having a two-layer structure comprising a carrier layer 25 and a functional layer 26. Carrier layer 25 and functional layer 26 are again a constituent part of a rubber blanket used as a semi-finished product during the production of the rubber sleeve 24, the rubber blanket being shaped in the manner of a sleeve and being connected in the region of joint faces 27 and 28 of the carrier layer 25 and in the region of joint faces 29 and 30 of the functional layer 26. In the exemplary embodiment of FIG. 4, too, at least the joint faces 27 and 28 of the carrier layer 25 are enlarged, in order to absorb circumferential forces acting on the rubber sleeve 24 safely and in this way to ensure secure seating of the rubber sleeve 24 on a rubber-covered cylinder of a printing press.

In the exemplary embodiment of FIG. 4, both the joint faces 27 and 28 of the carrier layer 25 and the joint faces 29 and 30 of also the functional layer 26 are enlarged by the first joint edges of the joint faces extending over the axial width of the rubber sleeve 24 being profiled in the axial direction. In the exemplary embodiment of FIG. 4, these first joint edges are jagged or shaped like a zigzag. In this way, the joint faces 27 to 30 of carrier layer 25 and functional layer 26 inter-engage with the effect of a toothing system extending in the axial direction of the rubber sleeve 24. Other profiles of the first joint edges are also possible, for example, undulating profiles.

The common feature of the exemplary embodiments of FIGS. 1 to 4 is that the rubber sleeves 10, 17 and 24 all have an at least two-layer structure comprising a carrier layer and a functional layer, the carrier layer and functional layer being a constituent part of a rubber blanket used as a semi-finished product during the production of the rubber sleeve. The rubber sleeves 10, 17 and 24 according to the invention do not have a rigid carrier sleeve made of metal or composite material but only the layers of the rubber blanket from which the respective rubber sleeve is produced.

In the exemplary embodiments of. FIGS. 1 to 4, joint faces at least of the carrier layer are enlarged in order that the carrier layer can reliably absorb circumferential forces and thus ensures secure seating of the rubber sleeve on a rubber-covered cylinder of a printing press.

The carrier layers 11, 18 and 25 of the rubber sleeves 10, 17 and 24 are all formed as flexible or elastic, fiber-reinforced plastic layers. Further layers, for example a register layer, can be positioned between the carrier layers 11, 18 and 25 and the functional layers 12, 19 and 26 of the rubber sleeves 10, 17 and 24.

At this point, it should be pointed out that the zigzag-shaped design of the first joint edges extending in the axial direction can be combined with the exemplary embodiments of FIGS. 2 and 3.

During the production of the rubber sleeves 10, 17 and 24 of the exemplary embodiments according to FIGS. 1 to 4, the procedure is such that a rubber blanket having the appropriate number and composition of the layers of the subsequent rubber sleeve is provided. The rubber blanket provided has an at least two-layer structure comprising a carrier layer and a functional layer. The rubber blanket provided is processed in the region of side faces used as joint faces, specifically in such a way that at least the joint faces of the carrier layer of the rubber blanket are enlarged. The rubber blanket is then shaped in the manner of a sleeve and connected to itself in the region of the adjacent joint faces. The connection is made by means of adhesive bonding, welding or vulcanizing.

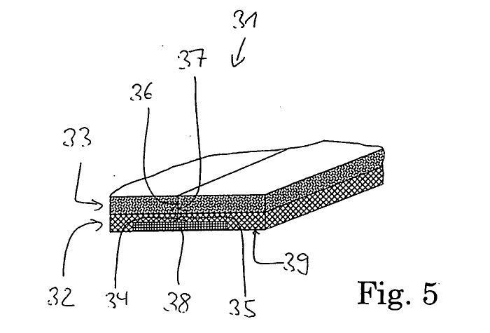

FIG. 5 shows a further rubber sleeve 31 according to the invention having a two-layer structure, comprising at least a carrier layer 32 and a functional layer 33 used for the printing process. Carrier layer 32 and functional layer 33 are again a constituent part of a rubber blanket used as a semi-finished product during the production of the rubber sleeve 31 according to the invention, which is shaped in the manner of a sleeve during the production of the rubber sleeve and is connected to itself in the region of mutually opposite joint faces 34 and 35 of carrier layer 32 and also mutually opposite joint faces 36 and 37 of functional layer 33.

However, in the exemplary embodiment of FIG. 5, as distinct from the exemplary embodiment of FIGS. 1 to 4, the joint faces 34 to 37 of carrier layer 32 and functional layer 33 are not enlarged; instead, these joint faces extend in the radial direction and meet one another flush. In the exemplary embodiment of FIG. 5, a connecting element 38 is let into the carrier layer 32. The connecting element 38 can be formed as a reinforcement made of metal, textile, plastic or composite material. The connecting element 38 is let into the carrier layer 32 in such a way that it absorbs circumferential forces acting on the rubber sleeve 31 reliably and in this way ensures secure seating of the rubber sleeve 31 on a rubber-covered cylinder of a printing press.

The connecting element 38 preferably extends over the entire axial width of the rubber sleeve 31 in the region of the joint faces 34 and 35 of the carrier layer 32, the connecting element overlapping on both sides in the circumferential direction the joint region provided by the joint faces 34 and 35. The connecting element 38 is also let into the carrier layer 32 in such a way that it does not project with respect to an inner face 39 of the carrier layer 32.

The carrier layer 32 of the rubber sleeve 31 of FIG. 5 is again preferably formed as a fiber-reinforced, flexible carrier layer. Further layers, for example a compressible layer, a register layer and a top layer, can be positioned between the carrier layer 32 and the functional layer 33 of the rubber sleeve 31.

During the production of the rubber sleeve 31 shown in FIG. 5, the procedure is such that, firstly, a rubber blanket having the desired layers of the rubber sleeve to be produced is provided. This rubber blanket is shaped in the manner of a sleeve and connected to itself in the region of its joint faces. The connection is again preferably made by means of welding, adhesive bonding or vulcanizing. In this case, the connecting element 38 is introduced into the carrier layer 32 in such a way that the inner side of the carrier layer 32 is free of joints/flush with the surface. One exemplary embodiment is to machine a recess matched to the dimension of the connecting element 38 into the carrier layer 32, into which recess the connecting element 38 is then inserted and firmly connected to the carrier layer 32 by welding or adhesive bonding.

None of the rubber sleeves according to the invention has a rigid carrier sleeve made of metal or composite material. All the layers of the rubber sleeves according to the invention are provided by a rubber blanket, which is provided as a semi-finished product during the production of the rubber sleeves.

### LIST OF REFERENCE SYMBOLS

10 Rubber sleeve
11 Carrier layer
12 Functional layer
13 Joint face
14 Joint face
15 Joint face
16 Joint face
17 Rubber sleeve
18 Carrier layer
19 Functional layer
20 Joint face
21 Joint face
22 Joint face
23 Joint face
24 Rubber sleeve
25 Carrier layer
26 Functional layer
27 Joint face
28 Joint face
29 Joint face
30 Joint face
31 Rubber sleeve
32 Carrier layer
33 Functional layer
34 Joint face
35 Joint face
36 Joint face
37 Joint face
38 Connecting element
39 Inner face

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A rubber sleeve for a printing press, having an at least two-layer structure, wherein an inner layer is formed as a carrier layer and an outer layer is formed as a functional layer and used for a printing process, the carrier layer and the functional layer being a constituent part of a rubber blanket, which is shaped in a manner of a sleeve in order to form the rubber sleeve and is connected to itself in a region of mutually opposite joint faces of the carrier layer and functional layer, and at least the joint faces of the carrier layer are enlarged in such a way that the joint faces of the carrier layer absorb a circumferential force acting on the rubber sleeve.

2. The rubber sleeve according to claim 1, wherein at least the joint faces of the carrier layer are set obliquely with respect to a radial direction of the rubber sleeve.

3. The rubber sleeve according to claim 2, wherein the joint faces of the functional layer extend in the radial direction of the rubber sleeve.

4. The rubber sleeve according to claim 2, wherein the joint faces of the functional layer are set obliquely with respect to the radial direction of the rubber sleeve.

5. The rubber sleeve according to claim 1, wherein the joint faces of the carrier layer and the functional layer are bounded by joint edges, wherein first joint edges extend over an axial width of the rubber sleeve and second joint edges extend over a radial thickness of the rubber sleeve.

6. The rubber sleeve according to claim 5, wherein at least the second joint edges of the carrier layer are set obliquely with respect to a radial direction of the rubber sleeve.

7. The rubber sleeve according to claim 6, wherein the second joint edges of the functional layer extend in the radial direction of the rubber sleeve.

8. The rubber sleeve according to claim 6, wherein the second joint edges of the functional layer are set obliquely with respect to the radial direction of the rubber sleeve.

9. The rubber sleeve according to claim 5, wherein at least the first joint edges of the carrier layer are profiled in an axial direction of the rubber sleeve.

10. The rubber sleeve according to claim 9, wherein the first joint edges of the functional layer are profiled in the axial direction of the rubber sleeve.

11. The rubber sleeve according to claim 1, wherein a further layer is positioned between the carrier layer and the functional layer, and wherein joint faces of the further layer are formed in a same way as the joint faces of carrier layer and/or functional layer.

12. The rubber sleeve according to claim 1, wherein the carrier layer is formed as a fiber-reinforced flexible layer.

13. A method for production of a rubber sleeve for a printing press, comprising the steps of:
a) providing a rubber blanket having an at least two-layer structure, wherein an inner layer is formed as a carrier layer and an outer layer is formed as a functional layer and used for a printing process;
b) machining the rubber blanket in a region of side faces of the rubber blanket used as joint faces and enlarging at least the joint faces of the carrier layer;
c) shaping the rubber blanket in a manner of a sleeve; and
d) connecting the rubber blanket at the joint faces in order to form the rubber sleeve.

14. A rubber sleeve for a printing press, having an at least two-layer structure, wherein an inner layer is formed as a carrier layer and an outer layer is formed as a functional layer and used for a printing process, the carrier layer and the functional layer being a constituent part of a rubber blanket, which is shaped in a manner of a sleeve in order to form the rubber sleeve and is connected to itself in a region of mutually opposite joint faces of the carrier layer and the functional layer, and a connecting element let into the carrier layer which absorbs a circumferential force acting on the rubber sleeve.

15. The rubber sleeve according to claim 14, wherein the connecting element is let into the carrier layer in such a way that the connecting element extends over an entire axial width of the rubber sleeve in the region of the joint faces.

16. The rubber sleeve according to claim 14, wherein the connecting element is let into the carrier layer in such a way that the connecting element overlaps the joint faces of the carrier layer on both sides in a circumferential direction.

17. The rubber sleeve according to claim 14, wherein the connecting element is let into the carrier layer in such a way that the connecting element does not project with respect to an inner face of the carrier layer.

18. The rubber sleeve according to claim 14, wherein a further layer is positioned between the carrier layer and the functional layer, and wherein joint faces of the further layer is formed in a same way as the joint faces of the carrier layer and/or the functional layer.

19. The rubber sleeve according to claim 14, wherein the carrier layer is formed as a fiber-reinforced flexible layer.

20. A method for production of a rubber sleeve for a printing press, comprising the steps of:
a) providing a rubber blanket having an at least two-layer structure, wherein an inner layer is formed as a carrier layer and an outer layer is formed as a functional layer and used for a printing process;
b) shaping the rubber blanket in a manner of a sleeve;
c) connecting the rubber blanket at joint faces of the rubber blanket; and
d) introducing a connecting element into the carrier layer.

21. A rubber sleeve for a printing press, comprising:
a rubber blanket having an inner layer and an outer layer;
wherein the outer layer includes a first face and a second face and wherein the first face adjoins the second face;
and further wherein the inner layer includes a first face and a second face and wherein the first and second faces of the inner layer adjoin each other and wherein a length of the first and second faces of the inner layer are enlarged with respect to a radial thickness or an axial width of the inner layer.

22. A method for production of a rubber sleeve for a printing press, comprising the steps of:
machining a rubber blanket having an inner layer and an outer layer to form first and second faces on the inner and outer layers, wherein the first and second faces of the inner layer have a length that is enlarged with respect to a radial thickness or an axial width of the inner layer; and
joining the first and second faces of the inner layer and the first and second faces of the outer layer.

23. A rubber sleeve for a printing press, comprising:
a rubber blanket having an inner layer and an outer layer;
wherein the outer layer includes a first face and a second face and wherein the first face adjoins the second face and further wherein the inner layer includes a first face and a second face and wherein the first and second faces of the inner layer adjoin each other; and
a connecting element disposed within the inner layer and extending across the joined first and second faces of the inner layer.

24. A method for production of a rubber sleeve for a printing press, comprising the steps of:
machining a rubber blanket having an inner layer and an outer layer to form first and second faces on the inner and outer layers;
joining the first and second faces of the inner layer and the first and second faces of the outer layer; and
disposing a connecting element within the inner layer, wherein the connecting element extends across the joined first and second faces of the inner layer.
